(19) United States
(12) Patent Application Publication
(10) Pub. No.: US 2007/0079890 A1
(43) Pub. Date: Apr. 12, 2007

(54) Fluid dispenser cleaning station and method for using the same

(76) Inventors: Stephen M. Bauer, Binghamton, NY (US); Scott N. Bettinger, Fairport, NY (US); Steven E. Damari, Vestal, NY (US); Michael A. Gorda, Johnson City, NY (US); James M. McDonough, Harpursville, NY (US); Scott C. Watson, Corbettesville, NY (US)

Correspondence Address: SCHMEISER, OLSEN & WATTS, 22 CENTURY HILL DRIVE, SUITE 302, LATHAM, NY, 12110, US

(21) Appl. No.: 11/130,703

(22) Filed: May 17, 2005

(51) Int. Cl. B67C 3/02

(52) U.S. Cl. 141/91

(57) ABSTRACT

A fluid dispenser, or dispensing needle, cleaning station which provides a non-contact apparatus and method of cleaning the dispensing end of a fluid dispenser. The cleaning station includes gas dispensing devices attached to a frame. The gas dispensing devices control the application of pressurized gas to the dispensing end of a fluid dispenser such that excess material on the fluid dispenser is removed.

### FIELD OF THE INVENTION

The present invention relates generally to an apparatus and method for using the same to clean excess material from the dispensing end of a fluid dispenser. In particular, the present invention includes gas dispensing devices which direct pressurized gas onto the dispensing end of a fluid dispenser, such that excess material is removed from the fluid dispenser.

### BACKGROUND OF THE INVENTION

Fluid dispensing mechanisms and their uses are well known. A dispensing mechanism typically supplies dispensing material to a surface via a fluid dispenser such as a needle through which the material to be dispensed flows. Typically, excess dispensed material accumulates at the dispensing end of the fluid dispenser. The buildup of dispensed material can cause problems in a number of ways such as poor calibration of the dispensing mechanism, excess dispense material at the dispense site, and contamination of the needle. For example, the dispensing mechanism may be programmed to dispense more than one type of material in a particular application. If the excess of the first material is not removed from the fluid dispenser, it can cause contamination when the second material is applied. In addition, among other problems, the excess dispensed material may cause false readings in a fluid dispenser calibration station. Existing methods of cleaning can be cumbersome to maintain and may damage the fluid dispenser. Thus, a need exists to address the problems heretofore described.

### SUMMARY OF THE INVENTION

The present invention provides an apparatus and method for using the same for removing excess dispense material at the dispensing end of a fluid dispenser, such as a dispensing needle. A cleaning station uses pressurized gas directed at the dispensing end of the fluid dispenser to remove the excess material. The cleaning station includes one or more gas dispensing devices through which the pressurized gas flows. The gas dispensing devices direct the gas toward the dispensing end of the fluid dispenser. The present invention provides an apparatus that is easy to maintain and a method for cleaning the dispensing end of the fluid dispenser.

A first general aspect of the present invention provides an apparatus for cleaning excess material from a dispensing end of a fluid dispenser comprising:

a frame including an opening;

at least one gas dispensing device attached to said frame and operable to direct pressurized gas onto the dispensing end of the fluid dispenser when the fluid dispenser is stationed in said opening; and

a pressurized gas supply, wherein said pressurized gas supply is operatively attached to said gas dispensing device.

A second general aspect of the present invention provides a method of cleaning the dispensing end of a fluid dispenser comprising the steps of:

providing a cleaning station having a pressurized gas supply;

positioning the dispensing end of the fluid dispenser in said cleaning station; and

applying pressurized gas from said pressurized gas supply to the dispensing end of the fluid dispenser such that excess material on the dispensing end of the fluid dispenser is removed.

### BRIEF DESCRIPTION OF THE DRAWINGS

Some of the embodiments of this invention will be described in detail, with reference to the following figures, wherein like designations denote like members, wherein:

FIG. 1 illustrates a side view of a dispensing mechanism including a fluid dispenser in accordance with an embodiment of the present invention;

FIG. 2 illustrates a side view of a fluid dispenser requiring cleaning;

FIG. 3A illustrates a side-view of an apparatus for cleaning the dispensing end of a fluid dispenser and a fluid dispenser positioned outside of the apparatus in accordance with an embodiment of the present invention;

FIG. 3B illustrates a side view of an apparatus for cleaning the dispensing end of a fluid dispenser and a fluid dispenser stationed in the apparatus in accordance with an embodiment of the present invention;

FIG. 3C illustrates a side view of an apparatus for cleaning the dispensing end of a fluid dispenser and a fluid dispenser stationed in the apparatus in accordance with the present invention-accordance with an embodiment of the present invention; and

FIG. 4 depicts a flowchart of a method of cleaning a fluid dispenser in accordance with one embodiment of the present invention.

### DETAILED DESCRIPTION OF THE INVENTION

Although certain embodiments of the present invention will be shown and described in detail, it should be understood that various changes and modification may be made without departing from the scope of the appended claims. The scope of the present invention will in no way be limited to the number of constituting components, the materials thereof, the shapes thereof, the relative arrangement thereof, etc. and are disclosed simply as an example of an embodiment. Although the drawings are intended to illustrate the present invention, the drawings are not necessarily drawn to scale.

The present invention pertains to an apparatus for cleaning the dispensing end of a fluid dispenser such as a needle. The inventive apparatus and the method of use thereof provides a less costly, easy to maintain and workable solution in which to clean a fluid dispenser.

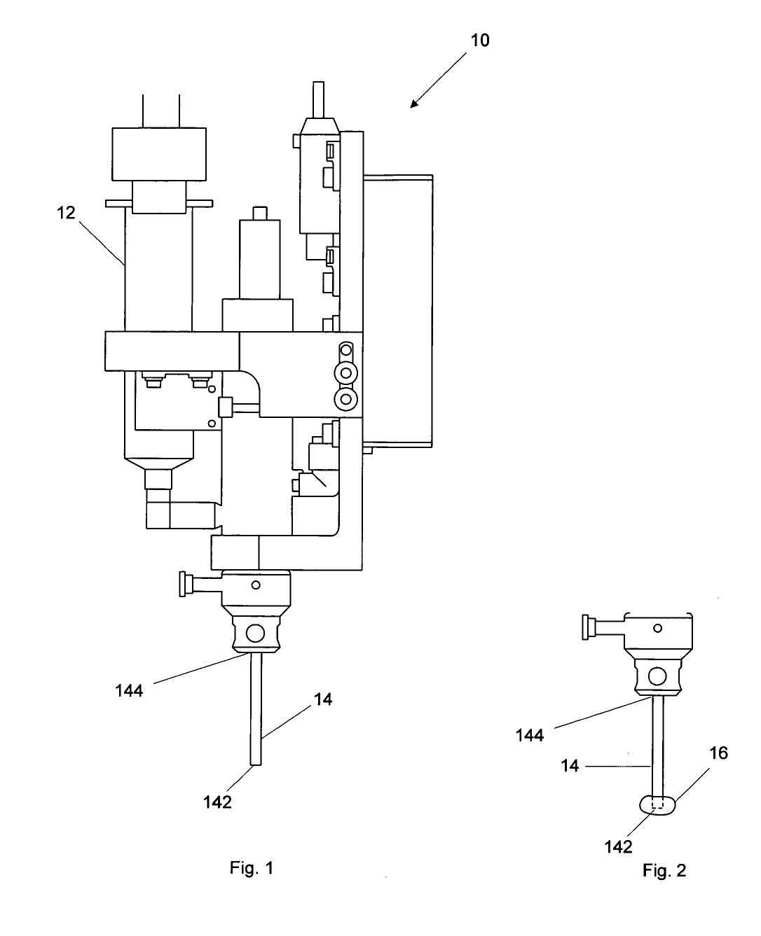

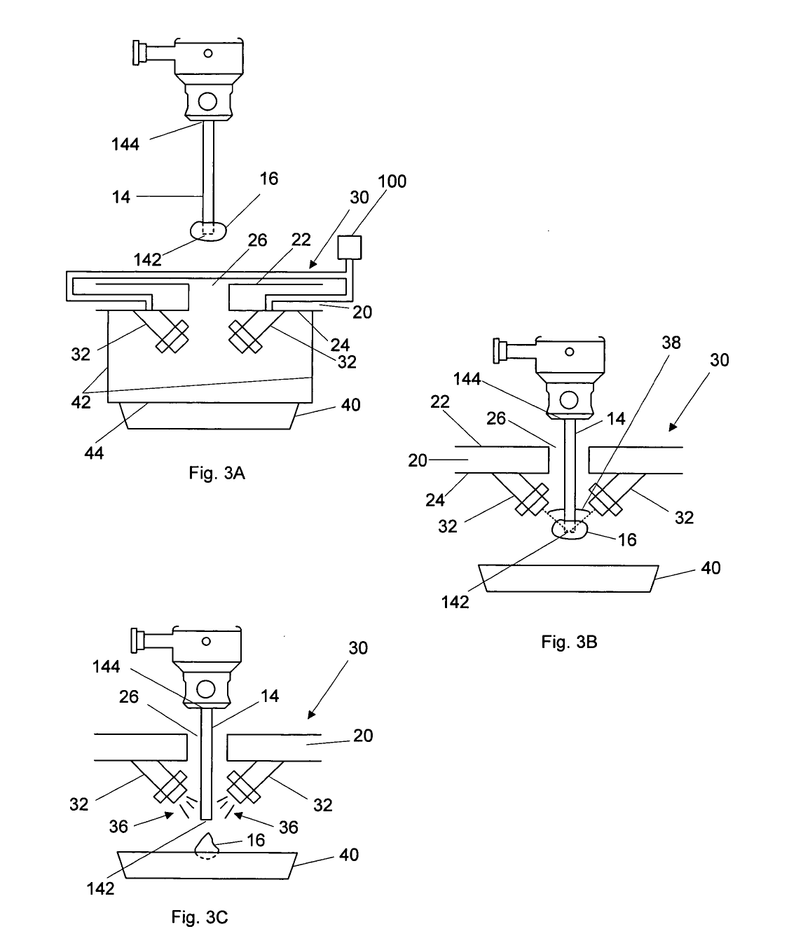

FIG. 1 depicts a dispensing mechanism 10 to be used in conjunction the cleaning station 30 (see FIG. 3) of the present invention. Dispensing mechanism 10 comprises at least a means of supplying dispensing material such as syringe 12, as well as a fluid dispenser, or needle, 14 attached at the distal end of dispensing mechanism 10 through which the material to be dispensed flows. The fluid dispenser 14 has a first, or proximate, end 144 and a second, or dispensing, end 142. The dispensing mechanism 10 may dispense a plurality of different materials for a variety of applications. When dispensed, these materials adhere or wick on to the dispensing end, or distal end, 142 of the fluid dispenser 14 causing excess material 16 to accumulate (see FIG. 2).

An embodiment of the present invention is shown in FIGS. 3A, 3B, and 3C. As shown in FIG. 3C, the fluid dispenser cleaning station 30 cleans excess material 16 from the dispensing end 142 of the fluid dispenser 14. The cleaning station 30 has a frame 20 including an opening 26. There is at least one gas dispensing device 32 attached to the frame 20. A pressurized gas supply 100 is operatively attached to each gas dispensing device 32. The pressurized gas 36 may be air, nitrogen, or any pressurized gas that may be directed at an object. The gas dispensing device 32 may have least one valve which controls the flow of pressurized gas 36 and, thus, the force that is applied to the fluid dispenser 14 to remove the excess material 16. To actuate the gas, a pneumatic solenoid valve and a flow control valve may be utilized. The gas dispensing device 32 is operable to direct pressurized gas 36 onto the dispensing end 142 of the fluid dispenser 14. The cleaning station 30 may be a non-contact cleaning station which allows the dispensing end 142 of the fluid dispenser 14 to be cleaned without contacting the fluid dispenser. In addition, a receptacle, or catch basin, 40 may be positioned to catch material 16 removed from the fluid dispenser 14.

The frame 20 has a first, or top, side 22 and a second, or bottom, side 24. The frame 20 may be constructed of one piece of material having an opening 26. However, the frame 20 may also be formed from more than one slab of material or any construction that supports the gas dispensing devices 32 and allows the fluid dispenser to enter the cleaning station. The frame 20 may be formed from metal, wood, plastic or any material that supports the gas dispensing devices 32. The frame 20 may be injection molded. The frame 20 may be formed of a material that is easy to clean and does not require a surface treatment.

In addition, the frame 20 may contain mounting features for fittings such as barbed pneumatic fittings. One or more gas dispensing devices, or gas jets, 32 are mounted to the bottom side 24 of the frame 20 such that the gas dispensing devices 32 are directed toward a point below the opening 26 into which the fluid dispenser 14 is lowered. The gas dispensing devices 32 may be mounted to direct pressurized gas 36 at an angle of application 38 which allows the excess material 16 to be blown or forced off of the fluid dispenser 14. The angle 38 may be any angle that allows the pressurized gas 36 emitted by the gas dispensing devices 32 to affect the dispensing end 142 of the fluid dispenser 14 such that the excess material 16 is removed from, or cleaned off of, the fluid dispenser 14 without exiting the opening 26 and such that the excess material 16 removed may be directed away from the opening 26 and be caught by a receptacle, or catch basin 40. As shown in FIGS. 3A, 3B, and 3C, the receptacle 40 retains the removed material for later disposal. For example, the embodiment shown in FIGS. 3A, 3B, and 3C shows an angle 38 which is essentially 45-degrees in relation to the dispensing end 142 of the fluid dispenser 14 while stationed in the cleaning station. Once the gas dispensing devices 32 are activated, the excess material 16 is directed away from the opening 26 and toward a receptacle 40. If there are two or more gas dispensing devices 32, the gas dispensing devices 32 may be mounted at the same angle or at different angles. Additionally, the gas dispensing devices 32 may be fixedly mounted to the frame 20 or may be rotatably attached to the frame 20.

The fluid dispenser 14 may be controlled by a programmable positioning system, which locates the fluid dispenser 14 into the frame opening 26 for cleaning and out of the opening 26 once the cleaning is complete. The positioning system may transport either the fluid dispenser 14 or the cleaning station 30. For example, the positioning system may control the fluid dispenser 14 and move the fluid dispenser 14 into the opening 26 of the cleaning station 30 when the fluid dispenser needs cleaning, such as before the fluid dispenser 14 is calibrated. Alternatively, the positioning system may operate the cleaning station 30 and transport the station 30 to the fluid dispenser 14 such that the opening 26 is stationed around the fluid dispenser 14 when cleaning is required.

The positioning system may be programmed to station the dispensing end 142 of the fluid dispenser 14 into the frame opening 26 for a selected duration. For example, a user may program the positioning system to keep the fluid dispenser 14 in the cleaning station for any amount of time that is determined by the user to be ideal for removing excess material 16 from the fluid dispenser 14.

As shown in FIGS. 3A, 3B, and 3C, a receptacle, or catch basin, 40 may be included to catch the excess material 16 cleaned from the fluid dispenser 14. The receptacle 40 may be a plate, a container, a cup, a catch basin, a bag, or any means that catches the excess material that is removed. The receptacle 40 may be attached to the frame 20 in any manner that secures the receptacle 40 in a location that will catch the excess material 16 removed in the cleaning station 30. For example, the receptacle 40 may be attached to the frame 20 via standoffs 42 on the frame 20 that are attached to a receptacle holding bracket 44. Alternatively, the receptacle 40 may be unattached to the frame 20 and rest on a surface below the cleaning station 30. The receptacle 40 may be removable and may be disposable.

FIGS. 3A, 3B, and 3C illustrate one embodiment of stages of cleaning the dispensing end 142 of a fluid dispenser 14 with cleaning station 30. FIG. 3A shows an embodiment of a first stage of cleaning the fluid dispenser 14 where dispensing mechanism 10, including the fluid dispenser 14, is positioned such that fluid dispenser 14 is aligned with opening 26. FIG. 3B illustrates the fluid dispenser 14 after it is moved through opening 26 so that it is positioned, or stationed, in the cleaning station 30. FIG. 3C illustrates the fluid dispenser 14 in position in the cleaning station while the gas dispensing devices, or gas jets, 32 allow pressurized gas 36 to be blown on to fluid dispenser 14 causing the excess material 16 to be removed and fall into the receptacle 40.

The pressurized gas 36 may be applied continuously, intermittently, or only when the dispensing end 142 of the fluid dispenser 14 is positioned in the cleaning station 30. The amount of time during which the pressurized gas is applied is the cleaning duration. The pressurized gas 36 maybe activated once the fluid dispenser 14 is positioned in the cleaning station 30 and deactivated when the dispensing end 142 of the fluid dispenser 14 is not positioned in the cleaning station 30, while fluid dispenser 14 is being removed from the cleaning station 30, or while fluid dispenser 14 is still positioned in the cleaning station 30. Thus, the cleaning duration may be correlated to when the dispensing end 142 of the fluid dispenser 14 is positioned in the cleaning station 30. Furthermore, the cleaning duration may be correlated to the viscosity of the excess material 16. For example, the duration that the pressurized gas 36 is applied may be longer for more viscous excess material 16. Similarly, the cleaning intensity, in other words the intensity of the pressurized gas 36, may be correlated to the viscosity of the excess material and be increased to remove dispense materials having greater viscosity.

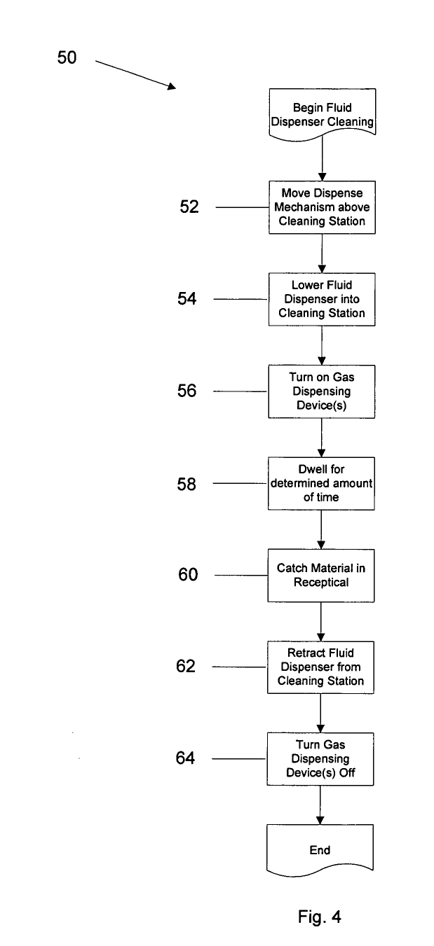

FIG. 4 shows a flow chart of an embodiment of present invention. The method of cleaning the dispensing end of a fluid dispenser 50 of fluid dispenser 14 begins in Step 52 by moving the dispensing mechanism 10 above cleaning station 30, so that the dispensing end 142 of the fluid dispenser 14 is aligned above the cleaning station 30. Once in position, the fluid dispenser 14 is lowered into cleaning station 30, as outlined in Step 54. The fluid dispenser may be lowered to a pre-programmed “z” height which is variable depending on the length of the fluid dispenser being used. The tip of the fluid dispending end 142 may be positioned at, below, or past, the point that the pressurized gas will be applied. Next, in Step 56, the gas dispensing devices, or gas jets 32 are turned on, for example by opening the valves in the gas dispensing devices, to allow pressurized gas 36 from the pressurized gas supply 100 to be applied through the gas dispensing devices 32 on to the dispensing end 142 of the fluid dispenser 14 such that excess material 16 on the dispensing end 142 of the fluid dispenser 14 is removed. The fluid dispenser remains in the cleaning station for a period of dwelling, or selected duration, Step 58. Step 60 represents that as pressurized gas 26 is applied to the fluid dispenser 14, excess material 16 that is blown off the fluid dispenser 14 may fall into a receptacle 40 which catches the excess material 16. Next, the fluid dispenser 14 is retracted from cleaning station 30, Step 62. Finally, the gas dispensing devices, or gas jets, 32 are turned off, Step 64.

The amount of time the fluid dispenser 14 is stationed in the cleaning station 30, or the selected dwelling time, may be an amount of time predetermined by a user, or by a computer processor which considers factors which apply to the fluid dispensing application at hand, and may vary for a variety of reasons such as the viscosity of the excess dispensed material 16. Similarly, the speed at which fluid dispenser 14 retracts from cleaning station 30, Step 62, may vary depending on the characteristics of the dispensed material and may be set by a user.

Since other modifications and changes varied to fit particular operating requirements and environments will be apparent to those skilled in the art, the invention is not considered limited to the example chosen for purposes of disclosure, and covers all changes and modification which do not constitute departures from the true spirit and scope of this invention. Such modifications and variations that may be apparent to a person skilled in the art are intended to be included within the scope of this invention as defined by the accompanying claims.

What is claimed is:

1. An apparatus for cleaning excess material from a dispensing end of a fluid dispenser comprising:
a frame including an opening;
at least one gas dispensing device attached to said frame and operable to direct pressurized gas onto the dispensing end of the fluid dispenser when the fluid dispenser is stationed in said opening; and
a pressurized gas supply, wherein said pressurized gas supply is operatively attached to said gas dispensing device.

2. The apparatus of claim 1, wherein said apparatus does not contact the fluid dispenser.

3. The apparatus of claim 1, wherein said gas dispensing device is mounted to direct pressurized gas at an essentially 45-degree angle in relation to the dispensing end of the fluid dispenser.

4. The apparatus of claim 1, further comprising:
a receptacle, wherein said receptacle is positioned to catch material removed from the fluid dispenser.

5. The apparatus of claim 4, wherein said receptacle is removable.

6. The apparatus of claim 4, wherein said receptacle is disposable.

7. The apparatus of claim 1, wherein said pressurized gas supply supplies pressurized air.

8. A method of cleaning a dispensing end of a fluid dispenser comprising the steps of:
providing a cleaning station having a pressurized gas supply;
positioning the dispensing end of the fluid dispenser in said cleaning station; and
applying pressurized gas from said pressurized gas supply to the dispensing end of the fluid dispenser such that excess material on the dispensing end of the fluid dispenser is removed.

9. The method of claim 8, wherein said cleaning station does not contact the fluid dispenser.

10. The method of claim 8, wherein the pressurized gas is applied continuously.

11. The method of claim 8, wherein the pressurized gas is applied intermittently.

12. The method of claim 8, wherein the pressurized gas is pressurized air.

13. The method of claim 8, further comprising:
stationing the dispensing end of the fluid dispenser in said cleaning station for a selected duration; and
removing the dispensing end of the fluid dispenser from said cleaning station after said selected duration.

14. The method of claim 8, further comprising:
correlating the application of the pressurized gas to when the dispensing end of the fluid dispenser is positioned in said cleaning station.

15. The method of claim 8, wherein said pressurized gas is applied for a cleaning duration, that correlates to the viscosity of the excess material,

16. The method of claim 8, wherein said pressurized gas is applied at a cleaning intensity that correlates to the viscosity of the excess material.

17. The method of claim 8 further comprising:
catching material removed in a receptacle.
